(19) United States
(12) Patent Application Publication
(10) Pub. No.: US 2012/0072484 A1
(43) Pub. Date: Mar. 22, 2012

(54) Method of Creating a Virtual Memorial Linked to an Online Family Tree

(76) Inventor: Steven M. GALIPEAU, Lancaster, NH (US)

(21) Appl. No.: 13/237,057

(22) Filed: Sep. 20, 2011

Related U.S. Application Data
(60) Provisional application No. 61/384,532, filed on Sep. 20, 2010.

(51) Int. Cl. G06F 15/16

(52) U.S. Cl. 709/203

(57) ABSTRACT

The software allows a user to create a virtual memorial, which is linked to an online family tree. The user's client account can be used to store personal memento data such as dairies, memoires, pictures, and videos. When the user creates a client account to access the software, the software assigns the client account to a family tree either by searching through a list of family trees or by creating a new family tree. The user can also create other family member profiles on the family tree through their client account. Family member profiles can be either a current profile or a memorial profile. The software automatically creates a current profile for the user and allows the user to create a memorial profile for a deceased relative. Finally, the software converts the current profile of the user into a memorial profile on the family tree once the user passes away.

The current application claims a priority to the U.S. Provisional Patent application Ser. No. 61/384,532 filed on Sep. 20, 2010.

### FIELD OF THE INVENTION

The present invention relates generally to a means of storing family history. More particularly, the present invention serves to store family material onto a web-based server to create an online family legacy.

### BACKGROUND OF THE INVENTION

Often, someone leaves their legacy behind in the from of writing such as journals, diaries, or letters. With the emergence of the internet and its unending availability to its users, online portals have become an integral part in just about every aspect of life, which includes the legacy that someone wants to leave behind when their life inevitably comes to an end.

Traditionally, many software products that allow a user to leave behind one's memories, notes taken during a special period of one's life, and picture or photo memories. However, many of these family legacy software products are rarely updated by the user and are easily left behind, thrown away, or forgotten. With the power of the internet, the present invention is an ever-accessible online family legacy, which allows a living family member to create a family tree and to store any mementos that he or she wants to leave behind for future generations of family members. The present invention also allows any living family member to update and fill out the online family tree with mementos of deceased relatives and to send electronic reminders to other living family members to update their own personal content. Through the use of the internet's vast storage space, the present invention provides an online venue for the legacy of a loved one to be readily available for future generations.

### BRIEF DESCRIPTION OF THE DRAWINGS

FIG. 1 is a block diagram illustrating the client-server architecture of the present invention.

FIG. 2 is a simplified flow chart depicting the overall process of the present invention.

FIG. 3 is a simplified flow chart depicting the process of assigning a client account to a family tree.

FIG. 4 is a simplified flow chart depicting the profile updating process.

FIG. 5 is a simplified flow chart depicting the process of converting a current profile into a memorial profile once the user passes away.

### DETAIL DESCRIPTIONS OF THE INVENTION

All illustrations of the drawings are for the purpose of describing selected versions of the present invention and are not intended to limit the scope of the present invention.

The present invention is a web-based method of creating a virtual memorial linked to an online family tree. The present invention executes its functions with a central server. The users of the present invention access the central server with a plurality of client accounts. Once the users log onto the central server with the plurality of client accounts, the present invention will assign each of the plurality of client accounts to a family tree from the list of family trees. The present invention will then allow the client accounts within the family tree to create a current profile for themselves or a memorial profile for a deceased relative. A profile update process sends an electronic reminder to each of the plurality of client accounts to update their current profile. Also, if the user of a client account passes away, then the present invention will convert the current profile of the user into a memorial profile.

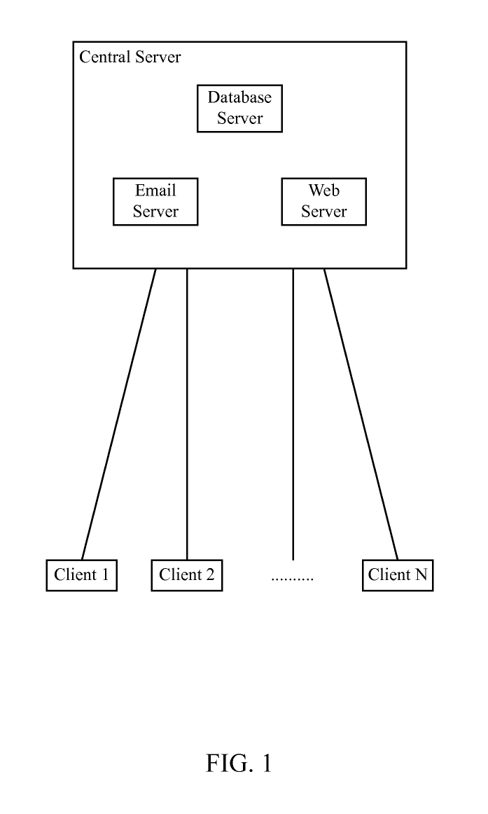

As can be seen in FIG. 1, the present invention uses a client-server model between the plurality of client accounts and the central server in order to perform its tasks. The central server comprises a database server, a web server, and an email server. The database server allows the central server to manage and store all of the data necessary to keep the present invention functioning. The web server allows the present invention to interact with the users through a variety of graphical user interfaces. The email server allows the present invention to communicate with the users via email. In the preferred embodiment of the present invention, the central server will be implemented and maintained by a company such as Google or Yahoo that can keep the present invention running on redundant systems. The company can maintain the central server because new users will continuously register with the present invention and, thus, will provide funding for the present invention. Also in the preferred embodiment, the company will provide access to the present invention on a global scale, which means the present invention should be able to accommodate users with multiple languages.

The plurality of client accounts allows the users to access the present invention and, thus, use the present invention. Each of the plurality of client accounts comprises profile data, personal memento data, proof of death data, family search criteria, and relative memento data. The profile data is a user's background information, which includes their first and last name, their email address and other contact information, their date of birth, and other such information. The personal memento data is information that the user would like to leave behind, which includes their personal thoughts, opinions, stories, memoires, advice, and anything that the user would like to express to future generations or to the user's family left behind. The proof of death data is certified electronic document verifying the user of the client account is legally dead. The family search criteria is background information on the user's family such as race, ethnicity, and country of origin. The relative memento data includes videos, pictures, and other information that could be used to remember a deceased relative of the user.

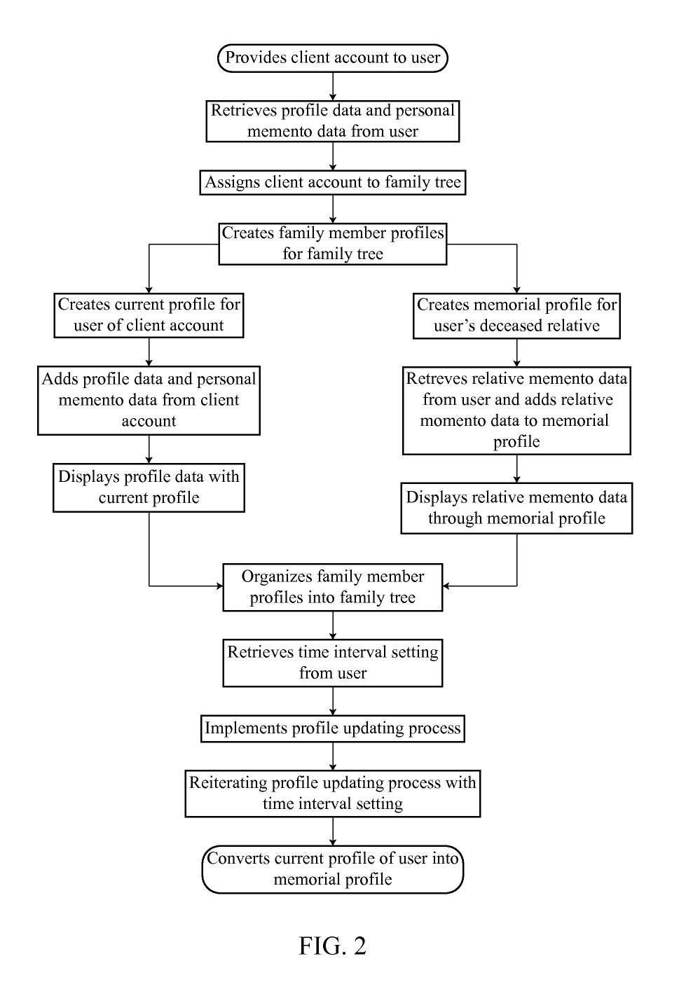

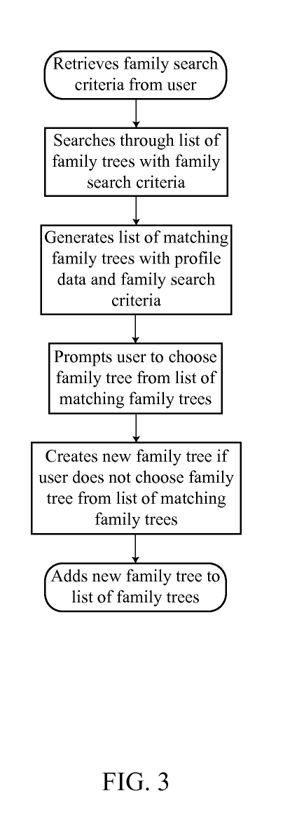

The other major component of the present invention is the list of family trees. A family tree records the relationships between all the members of a family, and, thus, comprises a plurality of family member profiles. The plurality of the family member profiles allows the present invention to share information about other client accounts within the family tree to the user. Each of the plurality of family member profiles can be either a current profile or a memorial profile. Each of the plurality of client accounts creates a current profile on their family tree, while deceased family members have a memorial profile on the family tree. Each of the plurality of family members profile has a lineage position and a lineage relation. The lineage position defines the position of each of the plurality of family member profiles in the family tree. For example, the lineage position would define if a family member is a parent, a sibling, and/or an in-law. The lineage relation of each of the plurality of family member profiles defines the relation between a family member and the other family members on the family tree. For example, the lineage relation would define who a family member is a parent, a sibling, and/or an in-law to. In the preferred embodiment of the present invention, a family tree is stored on the database server as a genealogical data communication (GEOCOM) file. GEOCOM files is the preferred file format to exchange genealogical data between different genealogy software and would allows a user to import genealogical data from another software to the present invention and vice versa. The users of the present invention follow a process shown in FIG. 2 to create a virtual memorial linked to an online family tree. The process begins by allowing the users to access the central server through the plurality of client accounts and acquiring essential information from each user. The present invention will retrieve the profile data from each of the plurality of client accounts as a means to distinguish one client account from another and will retrieve the personal memento data from each of the plurality of client accounts as a means to acquire more personal information about each user. In the preferred embodiment, the present invention will display a suggestion form to first-times users, which recommends what to include in their personal memento data. Once the present invention stores the profile data and the personal memento data of each of the plurality of client accounts to the database server, the present invention will assign each of the plurality of client accounts to a family tree by one of two methods, which are outlined in FIG. 3. For the first method, the present invention will attempt to locate the family tree of the user on the list family of trees. The present invention retrieves the family search criteria from the user in order to search through the list of family trees and generate a list of matching family trees. The list of matching family trees is a narrower version of the list of family trees and is specifically catered to each individual user according to their profile data and their family search criteria. The present invention will then display the list of matching family trees of each of the plurality of client accounts and prompt each of the plurality of client accounts to choose a family tree from their list of matching family trees. Each user can choose the second method of assigning their client account to a family tree if the user's family tree is not on the list of matching family trees. The second method allows the present invention to create a family tree for the user's family and to add that family tree to the list of family trees. The present invention will then assign the user's client account to the newly created family tree.

Once each of the plurality of client accounts is assigned to their family tree, the present invention allows each of the plurality of client accounts to create family member profiles for their family tree. The present invention automatically creates a current profile for each of the plurality of client accounts on their family tree. The present invention then adds the profile data and the personal memento data of each of the plurality of client accounts to their current profile, which allows the present invention to display the profile data of each of the plurality of client accounts through their current profile to the other client accounts assigned to their family tree. The personal memento data that is added to a current profile is not displayed by the present invention because the user usually wants to keep personal memento data private from other client accounts within the same family tree, until the user passes away. Additionally, the present invention allows each of the plurality of client accounts to create a memorial profile for a deceased relative on their family tree. When the present invention creates the memorial profile on the family tree, the present invention will retrieve the relative memento data from the client account that choose to create the memorial profile. The relative memento data is added to the memorial profile of the deceased relative and is displayed by the present invention to the client accounts within the same family tree. In preferred embodiment, the present invention will charge a client account with an additional fee to add relative memento data to a memorial profile. If the present invention creates a current profile or a memorial profile on a family tree, then the present invention must properly arrange the current profile or the memorial profile among the plurality of family member profiles. The present invention retrieves the lineage relation and the lineage position of each of the plurality of family member profiles on a family tree from the client account that choose to create the current profile or the memorial profile. The present invention can then properly organize each of the plurality of family member profiles into the family tree according to its lineage position and lineage relation. The present invention will now be able to display the plurality of family member profiles to each of the plurality of client accounts assigned to the same family tree.

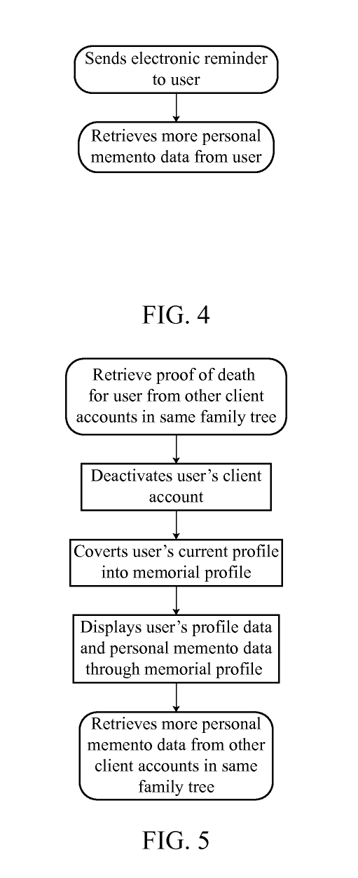

In FIG. 4, the present invention executes the profile update process as a means to add more recent information to the current profile of each of the plurality of client accounts. Before the profile update process begins, the present invention retrieves a time interval setting from each of the plurality of client accounts for their current profile. The time interval setting is the amount of time that present invention will wait before sending an electronic reminder to a client account with a current profile, which is how the profile update process begins. In the preferred embodiment of the present invention, the time interval setting is five years, and the electronic reminder is sent via the email server. Once the user of the client account receives and reads the electronic reminder, the present invention will retrieve more personal memento data from the user through the client account. For example, the user could upload new videos or new pictures recently taken by the user. The profile update process will repeat with the time interval setting, until the current profile is converted into a memorial profile.

The present invention eventually converts all of the current profiles into memorial profiles, which has a process shown in FIG. 5, because the users of the current profiles eventually pass away. When the user of a client account passes away, the present invention can retrieve the proof of death data from one of the other users with client accounts that are assigned to the same family tree. Once the present invention receives the proof of death data for a client account, the present invention starts by deactivating that client account because that client account will remain inactive. The present invention will then convert the current profile of the user that passes away into a memorial profile.

The memorial profile allows the present invention to display both the profile data and the personal memento data as a virtual memorial to the other users with client accounts assigned to the same family tree. The present invention will now allow the other client accounts on the same family tree to update the memorial profile by adding to the personal memento data. Similarly, the preferred embodiment of the present invention will charge an additional fee to the other client accounts on the same family tree for updating the memorial profile.

In order for the present invention to generate more revenue, the central server implements a number of miscellaneous features that persuades more users to create a client account on the present invention. One feature is an informational video that describes the key aspects of the present invention. The informational video could detail the benefits of having a virtual memorial and prompt the user to create a client account. Another feature is to allow a user to purchase and create a client account for a relative via a gift certificate. The user would purchases the gift certificate from the present invention to give to the relative so that the relative could create a client account free of charge. A last feature would be to allow the present invention to display advertisements on certain screens such as the screen that displays the family tree or the personal memento data.

Today more than ever, people are choosing cremation as an alternative to burial with no memorial at all. Every life is worth remembering. With the present invention, people would just be a click away from their deceased relatives or friends no matter where they were in the world or how far back they cared to venture into their family history that future generations will have an opportunity to feel as if the past ancestors were talking to them.

Although the invention has been explained in relation to its preferred embodiment, it is to be understood that many other possible modifications and variations can be made without departing from the spirit and scope of the invention as hereinafter claimed.

What is claimed is:

1. A method of creating a virtual memorial linked to an online family tree by executing computer-executable instructions stored on a non-transitory computer-readable medium, the method comprises the steps of:
providing a plurality of client accounts, wherein each of the plurality of client accounts includes profile data, personal memento data, a family search criteria, a proof of death data, and a relative memento data;
providing a list of family trees;
retrieving said profile data for each of said plurality of client accounts;
retrieving said personal memento data for each of said plurality of client accounts;
assigning each of said plurality of client accounts to a family tree from said list of family trees, wherein said family tree comprises a plurality of family member profiles;
providing a current profile and a memorial profile, wherein each of said plurality of family member profiles is either said current profile or said memorial profile;
creating said current profile for each of said plurality of client accounts within said family tree;
prompting each of said plurality of client accounts within said family tree to create said memorial profile for a deceased relative;
assigning a lineage position for each of said plurality of family member profiles;
assigning a lineage relation between said plurality of family member profiles;
displaying said plurality of family member profiles to each of said plurality of client accounts within said family tree;
retrieving a time interval setting from each of said plurality of client accounts;
executing a profile update process for each of said plurality of client accounts;
reiterating said profile update process at said time interval setting for each of said plurality of client accounts; and
converting said current profile of each of said plurality of client accounts into said memorial profile.

2. The method of creating a virtual memorial linked to an online family tree by executing computer-executable instructions stored on a non-transitory computer-readable medium, the method as claimed in claim 1 comprises, retrieving said family search criteria from each of said plurality of client accounts;
searching through said list of family trees with said family search criteria and said profile data of each of said plurality of family trees;
generating a list of matching family trees with said family search criteria and said profile data from said list of family trees;
displaying said list of matching family trees to each of said plurality of client accounts; and
prompting each of said plurality of client accounts to choose said family tree from said list of family trees.

3. The method of creating a virtual memorial linked to an online family tree by executing computer-executable instructions stored on a non-transitory computer-readable medium, the method as claimed in claim 2 comprises,
creating said family tree for each of said plurality of client accounts if said family tree is not found on said list of matching family trees; and
adding said family tree to said list of family trees.

4. The method of creating a virtual memorial linked to an online family tree by executing computer-executable instructions stored on a non-transitory computer-readable medium, the method as claimed in claim 1 comprises,
adding said profile data and said personal memento data from each of said plurality of client accounts within said family tree to said current profile of each of said plurality of client accounts with said family tree; and
displaying said profile data of each of said plurality of client accounts through said current profile of each of said plurality of client accounts on said family tree.

5. The method of creating a virtual memorial linked to an online family tree by executing computer-executable instructions stored on a non-transitory computer-readable medium, the method as claimed in claim 1 comprises,
retrieving said relative memento data for said memorial profile from each of said plurality client accounts within said family tree;
adding said relative memento data to said memorial profile; and
displaying said relative memento data through said memorial profile.

6. The method of creating a virtual memorial linked to an online family tree by executing computer-executable instructions stored on a non-transitory computer-readable medium, the method as claimed in claim 1 comprises,
prompting said plurality of client accounts within said family tree to enter said lineage relation and said lineage position for each of said plurality of family member profiles; and
organizing said family tree according to said lineage position of each of said plurality of family member profiles and according to said lineage relation between each of said plurality of family member profiles.

7. The method of creating a virtual memorial linked to an online family tree by executing computer-executable instructions stored on a non-transitory computer-readable medium, the method as claimed in claim 1 comprises,
sending an electronic reminder to each of said plurality of client accounts with said current profile; and
retrieving more of said personal memento data from each of said plurality of client accounts with said current profile.

8. The method of creating a virtual memorial linked to an online family tree by executing computer-executable instructions stored on a non-transitory computer-readable medium, the method as claimed in claim 1 comprises,
retrieving said proof of death data for each of said plurality of client accounts from said plurality of client accounts within said family tree;
deactivating each of said plurality of client accounts with said proof of death data;
converting said current profile of each of said plurality of client accounts with said proof of death data into said memorial profile;
displaying said profile data and said personal memento data of each of said plurality of client accounts with said proof of death data through said memorial profile; and
retrieving more of said personal memento data for each of said plurality of client accounts from said plurality of client accounts within said family tree.
